(19) United States
(12) Patent Application Publication
(10) Pub. No.: US 2026/0149707 A1
(43) Pub. Date: May 28, 2026

(54) Unified Resolution-as-Evidence Protocol and System for Policy-Enforced DNS Resolution with Knowledge Graph Injection, Global Identity and Object-Key Anchoring, and Time-Value Minting Based on a Pre-Established Identifier Reservoir.

(71) Applicant: FURONG BEI, SAN GABRIEL, CA (US)

(72) Inventor: FURONG BEI, SAN GABRIEL, CA (US)

(21) Appl. No.: 19/448,144

(22) Filed: Jan. 14, 2026

Related U.S. Application Data
(63) Continuation-in-part of application No. 19/056,745, filed on Feb. 19, 2025.
(63) Continuation-in-part of application No. 19/192,322, filed on Apr. 28, 2025.
(63) Continuation-in-part of application No. 19/196,039, filed on May 1, 2025.
(63) Continuation-in-part of application No. 19/072,412, filed on Mar. 6, 2025.
(63) Continuation-in-part of application No. 19/074,326, filed on Mar. 8, 2025, now abandoned.
(63) Continuation-in-part of application No. 19/076,910, filed on Mar. 11, 2025.
(63) Continuation-in-part of application No. 19/079,378, filed on Mar. 13, 2025.
(63) Continuation-in-part of application No. 19/078,276, filed on Mar. 13, 2025.
(63) Continuation-in-part of application No. 19/080,825, filed on Mar. 15, 2025.
(63) Continuation-in-part of application No. 19/083,396, filed on Mar. 18, 2025.
(63) Continuation-in-part of application No. 19/085,925, filed on Mar. 20, 2025.
(63) Continuation-in-part of application No. 19/084,806, filed on Mar. 20, 2025.
(63) Continuation-in-part of application No. 19/091,669, filed on Mar. 26, 2025.
(63) Continuation-in-part of application No. 19/096,717, filed on Apr. 1, 2025.
(63) Continuation-in-part of application No. 19/098,985, filed on Apr. 3, 2025.
(63) Continuation-in-part of application No. 19/172,519, filed on Apr. 7, 2025.
(63) Continuation-in-part of application No. 19/172,158, filed on Apr. 7, 2025.
(63) Continuation-in-part of application No. 19/174,286, filed on Apr. 9, 2025.
(63) Continuation-in-part of application No. 19/177,509, filed on Apr. 12, 2025.
(63) Continuation-in-part of application No. 19/182,542, filed on Apr. 17, 2025.
(63) Continuation-in-part of application No. 19/181,344, filed on Apr. 17, 2025.
(63) Continuation-in-part of application No. 19/183,133, filed on Apr. 18, 2025.
(63) Continuation-in-part of application No. 19/183,864, filed on Apr. 20, 2025.
(63) Continuation-in-part of application No. 19/186,416, filed on Apr. 22, 2025.
(63) Continuation-in-part of application No. 19/187,223, filed on Apr. 23, 2025.
(63) Continuation-in-part of application No. 19/204,518, filed on May 10, 2025.
(63) Continuation-in-part of application No. 19/211,012, filed on May 16, 2025.
(63) Continuation-in-part of application No. 19/211,289, filed on May 19, 2025, now abandoned.
(63) Continuation-in-part of application No. 19/218,272, filed on May 25, 2025.
(63) Continuation-in-part of application No. 19/224,923, filed on Jun. 2, 2025.
(63) Continuation-in-part of application No. 19/227,265, filed on Jun. 3, 2025, now abandoned.
(63) Continuation-in-part of application No. 19/314,019, filed on Aug. 29, 2025.
(63) Continuation-in-part of application No. 19/315,561, filed on Aug. 31, 2025.
(63) Continuation-in-part of application No. 19/346,531, filed on Sep. 30, 2025.
(63) Continuation-in-part of application No. 19/347,640, filed on Oct. 1, 2025.
(63) Continuation-in-part of application No. 19/355,998, filed on Oct. 10, 2025.
(63) Continuation-in-part of application No. 19/356,059, filed on Oct. 11, 2025.
(63) Continuation-in-part of application No. 19/356,153, filed on Oct. 12, 2025.
(63) Continuation-in-part of application No. 19/356,121, filed on Oct. 12, 2025.
(63) Continuation-in-part of application No. 19/356,190, filed on Oct. 13, 2025.
(63) Continuation-in-part of application No. 19/357,257, filed on Oct. 14, 2025.
(63) Continuation-in-part of application No. 19/360,780, filed on Oct. 16, 2025.
(63) Continuation-in-part of application No. 19/359,716, filed on Oct. 16, 2025.
(63) Continuation-in-part of application No. 19/362,339, filed on Oct. 17, 2025.
(63) Continuation-in-part of application No. 19/361,017, filed on Oct. 17, 2025.
(63) Continuation-in-part of application No. 19/365,182, filed on Oct. 22, 2025.
(63) Continuation-in-part of application No. 19/369,262, filed on Oct. 26, 2025.
(63) Continuation-in-part of application No. 19/370,475, filed on Oct. 27, 2025.
(63) Continuation-in-part of application No. 19/373,598, filed on Oct. 29, 2025.
(63) Continuation-in-part of application No. 19/372,269, filed on Oct. 29, 2025.
(63) Continuation-in-part of application No. 19/374,710, filed on Oct. 30, 2025.
(60) Provisional application No. 63/769,143, filed on Mar. 9, 2025.
(60) Provisional application No. 63/772,633, filed on Mar. 16, 2025.

(51) Int. Cl. H04L 9/40; G06Q 40/02; G06Q 50/16; H04L 61/4511

(52) U.S. Cl. CPC H04L 63/08; G06Q 40/02; G06Q 50/16; H04L 61/4511

(57) ABSTRACT

A policy-governed network resolution system generates a cryptographically verifiable Resolution Receipt (RR) for each identifier request. An identifier (e.g., a domain name under a BEIDNS/BEIDomain/BEITLD namespace) is routed to a resolver gateway, matched to a basepoint within a curated identifier reservoir, evaluated under a versioned policy container, and authorized by a signed scope token to enforce selective disclosure. The resolver may enrich the context with a knowledge-graph entity identifier, derive a decentralized identity root for Behavioral Economics Identity (BEI), and mint a content-addressable global object key. Minute-grade activity is metered and recorded in the RR, including policy version, reason codes, lifecycle state, audit anchors, and a signature chain, further supporting denial receipts with remediation steps. RR digests may be recorded in append-only logs and optionally anchored to a distributed ledger. Aggregated RR metrics may be streamed for real-time indexing, resource governance, and bounded rollback in IoT and real-estate embodiments.

### CROSS-REFERENCE TO RELATED MATERIALS

This application is a continuation-in-part of the application(s) identified in the Application Data Sheet (ADS) filed herewith, and claims the benefit of domestic priority under 35 U.S.C. Section 120 and 37 C.F.R. Section 1.78 to such application(s), including any continuation, divisional, or continuation-in-part chain properly identified in the ADS. The entire disclosure of each application identified in the ADS is incorporated herein by reference to the extent not inconsistent with the present disclosure. In the event of any inconsistency between this specification and the ADS regarding any claim for domestic benefit, the ADS shall control.

### STATEMENT REGARDING FEDERALLY SPONSORED RESEARCH

Not applicable.

### TECHNICAL FIELD

Overview. This specification describes a DNS-adjacent, policy-governed identifier resolution layer for BEI domain names and related identifiers. In exemplary implementations, standard DNS mechanisms are used for discovery (e.g., HTTPS/SVCB/URI records) to locate a resolver gateway endpoint, while governance, authorization, selective disclosure, and receipt issuance occur in the resolver gateway.

References to specific domain names (e.g., BEIDNS.org, BEIDNS.APP) are illustrative and non-limiting.

The disclosure relates to network name resolution, domain name system (DNS) security and policy enforcement, cryptographic attestation, decentralized and federated identity, object identification, auditability, and time-value accounting and settlement.

### BACKGROUND

DNS was designed primarily to map human-readable names to resource records such as IP addresses. Modern Internet and intranet deployments increasingly require: (i) fine-grained, policy-driven access and disclosure controls; (ii) cryptographically verifiable evidence of resolution decisions; (iii) audit trails for compliance, dispute resolution, and incident response; and (iv) mechanisms that can bind resolution events to identity, objects, and value-transfer systems.

Existing DNS security mechanisms provide important primitives—e.g., DNSSEC for integrity and authenticity, and encrypted transports such as DNS-over-HTTPS (DoH) and DNS-over-TLS (DOT)—but generally do not standardize a resolver output that functions as a portable, third-party-verifiable evidence receipt of the resolution decision.

Separately, decentralized identifiers (DIDs) and blockchains may provide identity and immutable anchoring, and knowledge graphs may provide entity semantics; however, these are typically external to DNS resolution. In addition, time-value representations (e.g., tokenizing verified time) exist but do not integrate a DNS-rooted, policy-enforced resolution pathway that produces a standardized evidence receipt and supports bounded corrective rollback.

### SUMMARY OF THE INVENTION

In one aspect, a resolver (or gateway) upgrades the DNS resolution process into a policy-enforced, evidence-producing protocol that outputs a standardized “Resolution Receipt” (RR). The RR includes (by way of example) a decision reason code, a policy-container version identifier, a signature chain, and one or more audit anchors. In some embodiments, the RR further includes: (i) time-duration and time-value fields that support minting or accounting of time-value units; (ii) knowledge-graph entity identifiers and confidence scores; (iii) global identity root identifiers (GI); and (iv) global object keys (GOK) for resources or events.

In another aspect, the system supports scope-based delegation via a Scope Token that encodes permitted audiences, time windows, field-level disclosure rules (minimum disclosure), purpose codes, and policy version constraints. In another aspect, the system supports lifecycle governance and bounded rollback, such as limiting rollback depth to three layers and the rollback window to seventy-two hours, while preserving immutable audit evidence.

### BRIEF DESCRIPTION OF THE DRAWINGS

FIG. 1 illustrates an end-to-end resolution-as-evidence flow producing an RR and optional audit anchors.

FIG. 2 illustrates a policy-container versioning and enforcement pipeline at a TLD or basepoint scope.

FIG. 3 illustrates a Scope Token structure for range-based delegation and minimum disclosure.

FIG. 4 illustrates bounded rollback and correction, including receipt freezing, revocation references, and cache invalidation.

FIG. 5 illustrates optional time-value minting and index publication based on RR events.

FIG. 6 illustrates optional knowledge graph injection, GI identity verification, and GOK object-key binding.

### DEFINITIONS AND TERMINOLOGY

The following terms are used for clarity; definitions are non-limiting.
Identifier (or Identifier String)—A resolvable string in one or more namespaces. An identifier may be a domain name, subdomain, URI, or other resolvable label.
Domain Name (as used herein)—Not limited to conventional DNS usage; may refer to any resolvable identifier that operates as a namespace entry and/or Basepoint node in the protocol.
Basepoint—A root node selected from the identifier reservoir that anchors policy execution, scope derivation, and receipt formation for a resolution event.
Parcel/Lot/Sub-Identifier—A scoped sub-identifier derived from a Basepoint (e.g., a subdomain) representing a subdivided namespace instance that can be bound to an entity, asset, user, or policy scope.
Policy Container—A versioned, machine-executable policy bundle (rules, coefficients, compliance toggles, reason codes) loaded by the resolver for a given Basepoint and scope.
Scope Token—A cryptographically verifiable token encoding scope, authorization, and compliance parameters that enables policy-governed resolution and selective disclosure.
Selective Disclosure—A policy-controlled disclosure mode that returns minimized or jurisdiction-appropriate subsets of RR fields while maintaining independent verifiability of the receipt.
Knowledge Graph (KG)—A semantic entity/relationship service used to enrich resolution context (e.g., Google Knowledge Graph or an equivalent KG service).
GI-DID (Global Identity Root)—A decentralized-identity anchor (e.g., W3C DID) binding a subject to resolution events and RR evidence.
GOK (Global Object Key)—A content-addressable object identifier derived from one or more of: KG entity IDs, Basepoint IDs, timestamps, and/or object hashes; used to bind physical/digital assets to RR evidence.
Resolution Receipt (RR)—A canonical, cryptographically signed, independently verifiable record emitted by the resolver, comprising policy metadata, reason codes, audit anchors, and metering/identity/object fields.

| Term | Meaning (non-limiting) |
|---|---|
| Basepoint | A primary identifier node (e.g., a domain name) |
| | that acts as a governance and resolution |
| | anchor; may spawn parcels/subdomains. |
| Parcel | A subdivided identifier namespace under a |
| | basepoint (e.g., a subdomain) representing |
| | a delegated space. |
| Policy Container | A versioned, auditable policy package |
| | bound to a TLD/basepoint/parcel that governs |
| | resolution decisions and disclosure rules. |
| Scope Token | A cryptographically verifiable token encoding |
| | range-based delegation: audience, time window, |
| | allowed fields, purpose, and policy-version |
| | constraints. |
| Resolution Receipt (RR) | A structured, signed evidence object produced |
| | by the resolver describing the decision, policy |
| | version, reason code, proofs, and optional |
| | anchors. |
| ER/DR/SR | Exemplary resolution outputs: Evidence |
| | Response (ER), Direct Response (DR), |
| | Structured Response (SR), optionally combined |
| | with RR. |
| GI (Global Identity) | A global identity root or DID-compatible |
| | identifier bound to a subject and used in |
| | authorization and receipts. |
| GOK (Global Object Key) | A globally unique key for a resource/event/ |
| | object (e.g., content-addressed identifier) bound |
| | to receipts for provenance and audit. |
| Bounded Rollback | A constrained correction mechanism limited by |
| | time (e.g., <=72 hours) and depth (e.g., <=3 |
| | layers), producing correction recipts. |

### System Overview and Architecture

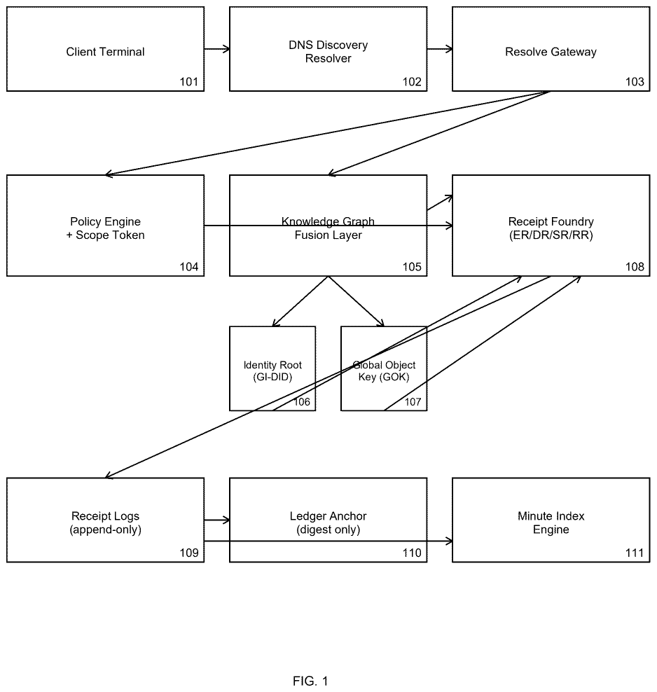

FIG. 1 depicts a system in which a resolver or gateway (e.g., hosted at ATMS.COM in one embodiment) processes a DNS-like query and produces both a resolution output and a standardized RR. The system may be implemented as an authoritative resolver, recursive resolver, enterprise DNS gateway, or application-level resolution service compatible with DNS/DoH/DOT transports.

### Core Components

| Component | Function | Notes/Examples |
|---|---|---|
| Genesis/Basepoint | Validates and | Appendix A inventory; |
| Registry | resolves | DNS zone files; registry |
| | basepoints/parcels; | DB. |
| | may consult a pre- | |
| | established | |
| | identifier | |
| | reservoir. | |
| Policy Engine + | Loads a versioned | TLD policy containers; |
| Policy | policy container | industry templates. |
| Containers | and evaluates | |
| | decision logic. | |
| Scope Delegation | Validates Scope | Selective disclosure rules. |
| Service | Tokens; enforces | |
| | minimum | |
| | disclosure. | |
| Lifecycle | Freeze/revoke/ | <=72 h, <=3 layers; |
| Governance | transfer/hold, | revocation lists. |
| Service | bounded rollback, | |
| | recovery | |
| | workflows. | |
| Receipt Forge (RR | Generates RR | Protobuf/CBOR/JSON. |
| Generator) | including reason | |
| | codes, policy | |
| | versions, signature | |
| | chain, anchors. | |
| Audit Anchor Bus | Anchors hashes to | Public chain, consortium |
| | one or more | chain, transparency log. |
| | ledgers/logs; | |
| | supports third- | |
| | party verification. | |
| Knowledge Graph | Resolves | External KG API; internal |
| Fusion Layer | domain/basepoint | KG. |
| | to entity IDs and | |
| | relations. | |
| GI Identity Root | Verifies subject | DID-compatible; eID; |
| | identity roots; | sign-in systems. |
| | issues/validates | |
| | identity assertions. | |
| GOK Object-Key | Generates object | CID-like identifiers; cloud |
| Generator | keys for resources/ | object keys. |
| | events; binds to | |
| | RR. | |
| Time-Value Engine | Computes | Index-driven valuation |
| | duration/value; | (e.g., beiindex.com). |
| | optionally mints or | |
| | accounts time- | |
| | value units. | |
| Index Publisher | Aggregates RR | Minute-level aggregates; |
| | events into | API feed. |
| | metrics/indices | |
| | (e.g., minute- | |
| | GDP). | |

### Pre-Established Identifier Reservoir (1999 Inventory)

In some embodiments, the disclosed protocol uses a pre-established BEI identifier “Reservoir,” initiated circa 1999 by Furong BEI, as a scalable naming substrate for global, long-horizon identity and governance. The Reservoir allocates basepoints and hierarchical namespaces to persons, families, organizations, industries, and jurisdictions, functioning as a durable, expandable “Treasure Bowl/Virgin Land” digital parcel that can be indefinitely subdivided via derived identifiers (e.g., subdomains).

This application is a continuation-in-part of the applications listed in the Application Data Sheet (ADS) filed herewith, the entire disclosures of which are incorporated herein by reference.

### Data Structures

### Resolution Receipt (RR)—Example Schema

The RR is a structured evidence object. Table 1 describes exemplary fields; implementations may include additional fields.

| Field | Type (example) | Purpose | Notes |
|---|---|---|---|
| rr_version | string | Receipt | May include |
| | | format/version | semantic version + |
| | | identifier | hash suffix. |
| policy_ | string | Policy container | May embed |
| version | | version applied | container hash. |
| reason_code | uint16 | Machine-readable | Industry ranges |
| | | decision reason | reserved; |
| | | | extensible. |
| timestamp_ | uint64 | Decision time | Unix seconds or |
| utc | | | ms. |
| query_name | string | Resolved name | Domain/basepoint/ |
| | | | parcel. |
| resolution_ | bytes/struct | ER/DR/SR payload | DNS RRset or |
| output | | | structured object. |
| sig_chain | repeated Sig | Multi-signer proof | Resolver, policy |
| | | chain | authority, operator. |
| audit_anchor | string/bytes | Anchor reference | Ledger tx hash; |
| | | | transparency log id. |
| bei_duration | uint32 | Time duration | From verified event |
| | | (minutes) | telemetry. |
| bei_value | decimal | Time-value units | May use index rate |
| | | | feed. |
| kg_entity_id | string | Knowledge graph | e.g., external KG |
| | | entity id | id. |
| kg_ | float | Entity confidence | Threshold gating |
| confidence | | score | possible. |
| gi_did_root | string | Identity root | DID-compatible |
| | | hash/DID | root. |
| gok_hash | string | Object key for | Content address or |
| | | resource/event | object key. |
| status | enum | ACTIVE/FROZEN/ | Used for |
| | | ROLLBACK/etc. | governance and |
| | | | correction. |
| revocation_ | string | Pointer to | Optional; supports |
| ref | | revocation/rollback | cache invalidation. |
| | | record | |

Exemplary deterministic data structures for the Resolution Receipt (RR or RRec), including signature-chain representation, are provided in Appendix B. Exemplary Scope Token (ST) templates, denial reason-code semantics, and remediation-step fields are provided in Appendix C. Canonicalization, hashing, signature verification, and rollback-impact reporting are described in the Detailed Description (e.g., receipt canonicalization and signature verification).

### Scope Token—Example Structure

A Scope Token encodes range-based delegation, minimum disclosure, and policy-version constraints.

Program Listing Reference (Non-limiting): Illustrative program listings, encoding examples, and test vectors are provided in a separate Code Appendix/Computer Program Listing attachment. For written-description and enablement, the present specification defines (i) the Resolution Receipt (RRec) field set (e.g., result_set, reason_code, policy_hash, policy_version, audit_anchor, signature_chain, revocation_ref, rollback_ref, ttl, bei_duration, bei_value, gi_did_root, gok_hash, kg_entity_id, demand_code, industry_code, regulation_id, resource_type, exchange_coin, savings_rate, status), (ii) deterministic hashing and signing inputs, and (iii) independent verification and bounded rollback procedures.

### Operational Flows

### Resolution-as-Evidence Flow

A non-limiting flow includes: (1) receive query; (2) map query to basepoint/parcel; (3) load policy container; (4) validate Scope Token; (5) compute decision and output ER/DR/SR; (6) generate RR with reason code, policy version, signature chain, and audit anchors; (7) return response to the requester; (8) optionally anchor RR hash and publish index metrics.

### Bounded Rollback and Correction

Upon a correction trigger (e.g., mis-binding, key compromise, policy error), a governance service may: (i) verify evidence; (ii) produce a rollback record within bounded constraints (e.g., <=72 hours, <=3 layers); (iii) freeze or revoke affected receipts and object keys; (iv) emit a correction RR referencing the prior RR; (v) invalidate caches based on revocation references; and (vi) preserve auditability via immutable anchors.

### Security, Privacy, and Compliance Considerations

Encrypted transports such as DoH and DoT may be used for confidentiality in transit. Minimum disclosure is enforced by Scope Token field allowlists. Receipts may be designed for third-party verification by including a complete signature chain and stable hash canonicalization.

In some embodiments, sensitive data is not embedded directly in the RR; instead, the RR includes references (e.g., object keys) to encrypted payloads, with access controlled by policy and delegation.

### Cryptographic Verification Test Vector (Non-Limiting, Deterministic Example)

To support independent verification and reproducibility, some embodiments define a canonical request payload and deterministic hashing procedure. The following test vector is non-limiting and is provided to enable third parties to reproduce identical bytes, hashes, and signature verification results.

Canonical JSON (UTF-8; keys sorted; no whitespace):
{“identifier”:“alice.medicalcenter.us”,“nonce”:“000102030405060708090A0B0C0D0E0
F”,“policy_version”:“1.0.0”,“scope”:{“identity_scope”:“subject”,“scene_scope”:“medical
_access”,“target_scope”:“record_read”},“time_window”:{“end_at”:“2026-01-
14T06:05:22Z”,“start_at”:“2026-01-14T05:05:22Z”}}
SHA-256 digest (hex) of canonical JSON:
d7bcb673a6a58bf778c9079d73b211b34e3219cecba96a4237f9d93b08205963
Ed25519 public key (base64, 32 bytes):
cSZR9FC6BbY4mLme9fe6RWMujiUn9/cVzWcexAJMxR4=
Ed25519 signature over canonical JSON (base64, 64 bytes):
0fJQhoQnezzu3J95MisGWuiw7dkUEhlnAgVgMG/dtpM2hQfZGFGzXtHDi9Q9nbqdew
bWZG0IdgnEwIG/m3VNDw==

Verification rule: verify (signature, canonical json, public_key) MUST return TRUE to accept the receipt chain; otherwise the client MUST treat the response as invalid and may emit a DR with RC-08 (INTEGRITY_FAIL).

### Exemplary Embodiments

### Medical Service (17-Minute Example)

A patient ‘Zhang San’ completes a medical consultation lasting 17 minutes. A client application submits a query for diabetes.zhangsan.beihealth.com. The resolver maps the basepoint to a medical policy container and validates a Scope Token issued to a clinician.

The policy authorizes minimum disclosure. The system optionally queries a knowledge graph to bind the request to a diabetes-related entity ID. The time-value engine records bei_duration=17 and computes bei_value using an index feed. An RR is generated and anchored. The RR serves as a verifiable evidence receipt for settlement, compliance, and audit.

### Supply Chain Mis-Binding and Rollback

A supply-chain parcel is mis-bound to an incorrect operator. Evidence is submitted within 72 hours. The governance service performs bounded rollback, invalidates affected object keys, emits a correction RR (status=ROLLBACK or RECOVERED), and forces cache invalidation via revocation references.

### Sovereignty Gateway and Regulatory Audit

A national or industry gateway operates policy containers at a TLD scope. Each resolution produces an RR that encodes policy version and reason codes. Auditors verify compliance by validating RR signature chains and anchors, without trusting the resolver operator.

### Exemplary Central-Bank Portal and Rule Publication (Worldcentralbank.Us: Worldbankcentral.Com)

In one non-limiting embodiment, an operator publishes an authoritative portal for time-denominated settlement and policy discovery at a resolvable basepoint (e.g., worldcentralbank.us and/or worldbankcentral.com). The portal can expose (i) a signed, versioned policy-container manifest, (ii) a resolver endpoint for generating enhanced resolution receipts (RRs), and (iii) a public dashboard reflecting a minute-index snapshot (e.g., via beiindex.com and/or minuteindex.org).

In such embodiment, a client submits a resolution request that includes an asserted activity duration and a scoped identifier (e.g., a sub-identifier derived from a curated basepoint). The resolver returns an enhanced RR that is tamper-evident (e.g., by cryptographic signature and/or by anchoring a digest to an audit chain) and that includes, without limitation, (a) duration, (b) computed value, (c) an identity-root reference, and (d) a minute-index reference to a contemporaneous snapshot identifier.

### Exemplary Time-Asset Dashboard and Wallet (Timeassets.Org; Timeassets.App)

In one non-limiting embodiment, a time-asset management interface is provided via a web endpoint and/or mobile endpoint (e.g., timeassets.org and timeassets.app). The interface can display balances of time-denominated units, pending receipts, lock states, and verification status, and can provide workflows to verify an RR by validating a signature and/or audit anchor digest.

In certain embodiments, the time-asset interface bridges settlement to one or more minting and exchange components (e.g., a minting basepoint such as beimint.com and an exchange/index basepoint such as beicx.com/bigx.com), while maintaining an immutable or append-only receipt history for auditability.

### Exemplary Time Savings Account and Compounding (Savingsbank.App: Minutebank.Org)

In one non-limiting embodiment, a ‘time savings account’ (TSA) is implemented by a client application (e.g., savingsbank.app) interoperating with a retail banking gateway (e.g., minutebank.org). The TSA can support lock-up periods, withdrawal rules, and rate parameters derived at least in part from a minute-index reference. The lock state can be recorded in the RR (e.g., a status field such as SAVINGS_LOCKED) such that downstream verifiers can independently confirm that units are subject to restrictions and policy controls.

In certain embodiments, the TSA supports inheritance and escrow-like controls (e.g., time-locked releases, designated beneficiaries, or dead-man switch triggers), with corresponding conditions recorded as receipt metadata and validated by a resolver policy container.

Exemplary Global Minute Index and Time-Denominated GDP Snapshot (minuteindex.org)

In one non-limiting embodiment, a minute-index service (e.g., minuteindex.org) publishes periodic snapshots that quantify aggregates of time-denominated activity metrics. A snapshot identifier can be referenced within each RR to provide a consistent valuation context and to enable independent recomputation or audit of derived values.

In certain embodiments, the minute-index service exposes an API for retrieving signed snapshot data and historical time-series, enabling derivative analytics such as sector-weighted indices, regional indices, or policy-trigger thresholds.

### Exemplary Global Identity Ingress Via GI Application (Beigi.App)

In one non-limiting embodiment, a client identity ingress application (e.g., beigi.app) is used to register or bind a subject to an identity root (e.g., a DID-compatible identifier) and to provision keys for receipt signing/verification.

In certain embodiments, the identity ingress supports multiple identity providers (e.g., W3C DID methods, federated sign-in, and/or national eID), while normalizing outputs to a common resolver interface and enabling privacy-preserving verification through scoped credentials.

### Real-Estate Time Coordinate, IoT Anchor, and Title-as-Receipt Embodiment

In one embodiment, a physical real-estate unit (e.g., an apartment, building, land parcel, or infrastructure asset) is represented as a time-coordinate identifier that is resolvable via the basepoint namespace. The identifier operates as a persistent address, a policy scope, and a settlement endpoint.

Example identifier (non-limiting): apt-001.chaoyang.beilots.com (or an equivalent sub-identifier under a designated housing or banking basepoint). The basepoint policy container stores, for the real-estate unit, parameters such as a remaining-duration limit (e.g., 70-year or 999-year tenure), a minimum collateral floor expressed in time units, and an associated global object key (GOK) that binds the identifier to a canonical property content-address (e.g., CID) and/or title registry record.

IoT anchoring: the real-estate unit may include one or more attested sensors (e.g., energy meter, water meter, door lock, temperature/humidity, air quality). At each reporting interval (e.g., per minute, per hour, or event-driven), an attested measurement bundle is produced, hashed, and anchored into the audit ledger. The measurement bundle may be used to (i) compute maintenance or resource time units attributable to the asset, (ii) validate habitability and compliance, and/or (iii) update risk, insurance, or sustainability metrics referenced by the policy container.

Title-as-Receipt: for title transfer, lease, mortgage, or lien operations, the system generates a Resolution Receipt (RREC) that includes (a) the property identifier, (b) the current policy version, (c) the GOK hash binding, (d) an IoT data anchor hash (if applicable), (e) a state field (e.g., OWNED, LEASED, MORTGAGED, RELEASED), and (f) a cryptographic signature and/or DNSSEC chain-of-trust evidence. The RREC thereby operates as a machine-verifiable digital deed that can be presented, validated, and audited without reliance on paper records.

Non-limiting example flow: a purchaser acquires a unit; the system binds the unit to a sub-identifier and initializes a policy container with tenure and collateral rules. After IoT onboarding, periodic IoT anchors update the asset's condition metrics. If the owner elects to borrow against time-value, a time-collateral portion is locked (e.g., within savingsbank.app) and the RREC state transitions to MORTGAGED; upon settlement, the lock is released and the state transitions back to OWNED.

This embodiment provides a technical improvement over conventional title systems by enabling (i) verifiable, cryptographically signed, machine-readable title receipts; (ii) automated state transitions and settlement controls; and (iii) optional IoT-backed condition anchoring that reduces fraud and improves auditability.

### Technical Effects and Advantages

Compared to conventional DNS resolution, the disclosed system can provide:
Standardized, portable evidence of resolution decisions (RR) with reason codes, policy versions, signatures, and anchors.
Range-based delegation and minimum disclosure enforced at resolution time via Scope Tokens.
Lifecycle governance with bounded rollback and auditable correction receipts.
Optional integration of knowledge-graph semantics, global identity roots, and object-key provenance.
Optional time-value accounting/minting tied to verified events, enabling minute-scale indices and settlement systems.

### Patentability-Oriented Technical Review (Non-Legal)

This section provides a technical framing commonly used to support patentability. It is not legal advice.

### Subject Matter Eligibility (35 U.S.C. Section 101)—Technical Improvement

The disclosure describes protocol-level and system-level improvements: new structured outputs (RR), policy-container versioning, scope-based delegation with minimum disclosure, cryptographic verification and audit anchoring, and bounded rollback mechanisms. These features can be implemented as concrete data structures and network-processing steps that improve the security, accountability, and governance of name resolution.

### Enablement and Written Description (35 U.S.C. Section 112)—Support Strategy

Enablement is supported by: (i) explicit field definitions and schemas for RR and Scope Tokens; (ii) described modules and interactions; (iii) exemplary embodiments; and (iv) appendices containing identifier inventory and implementation artifacts. The specification emphasizes deterministic verification steps and bounded correction conditions to avoid ambiguity.

### Novelty and Non-Obviousness (35 U.S.C. Section Section 102-103)—Differentiators

Prior approaches may include blockchain-based naming, DNS security extensions, identity systems, time-token protocols, and knowledge graphs. The differentiator is the integrated resolution-time closed loop that produces a standardized evidence receipt with policy versioning and reason codes, enforces scope-based minimum disclosure, supports bounded rollback, and optionally binds to knowledge entities, identity roots, and object keys.

### Commercialization, Licensing, and Asset Packaging (Non-Financial)

This section presents non-binding commercialization frameworks; actual valuation depends on adoption, enforceability, competition, and regulatory conditions.

### Typical Licensing Targets

| | | Potential Claim | Licensing Form |
|---|---|---|---|
| Target | Likely Use | Touchpoints | (examples) |
| DNS Resolver | Evidence- | Claims on RR | Per-QPS/per- |
| Operators/Public | producing policy- | generation, policy | domain annual |
| DNS | enforced resolution; | versioning, | license; SDK |
| | RR output | signature chain | license |
| Cloud DNS/ | Compliance and | Claims on Scope | SaaS subscription; |
| Enterprise | audit, minimum | Tokens, rollback, | per-instance license |
| Gateways | disclosure, | cache invalidation | |
| | revocation | | |
| Industry Platforms | Industry policy | Claims on industry | Vertical package |
| (health, supply | templates and | policy containers | license; revenue |
| chain) | governance | and field allowlists | share |
| Government/ | TLD-level policy | Claims on TLD | High-value |
| Sovereignty | enforcement and | policy containers, | operational license; |
| Gateways | audit | audit anchors, | managed services |
| | | correction receipts | |
| Index/Exchange | Minute-scale | Claims on time- | Index licensing; |
| Operators | indices based on | value engine and | data feed licensing |
| | RR events | index publication | |

### Asset Package Composition

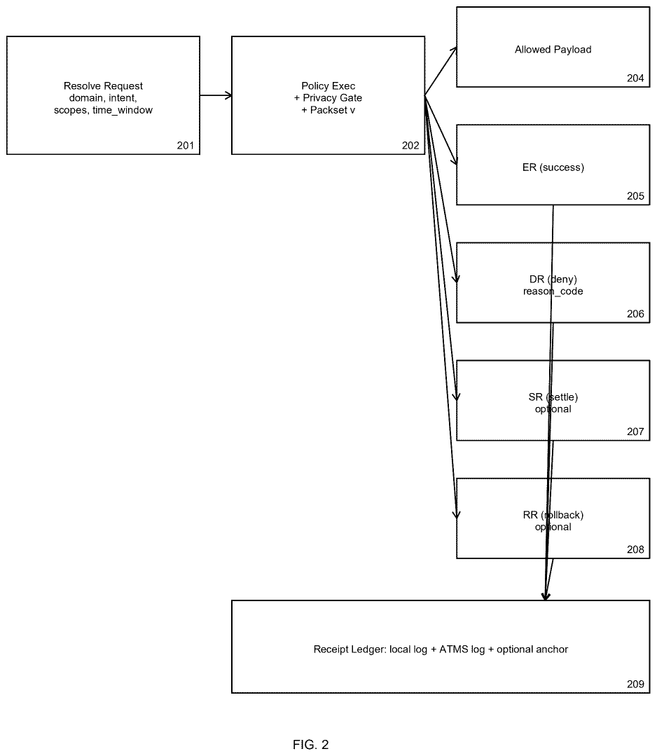

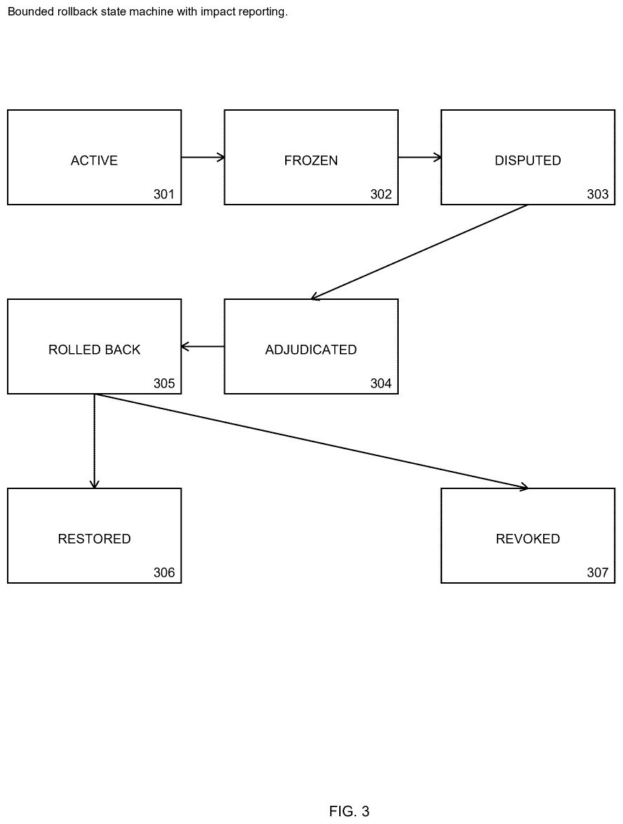

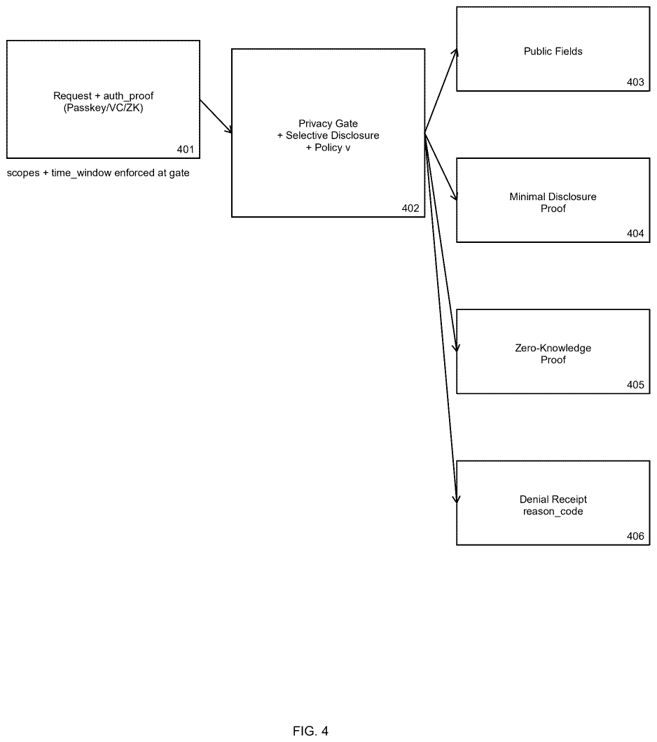

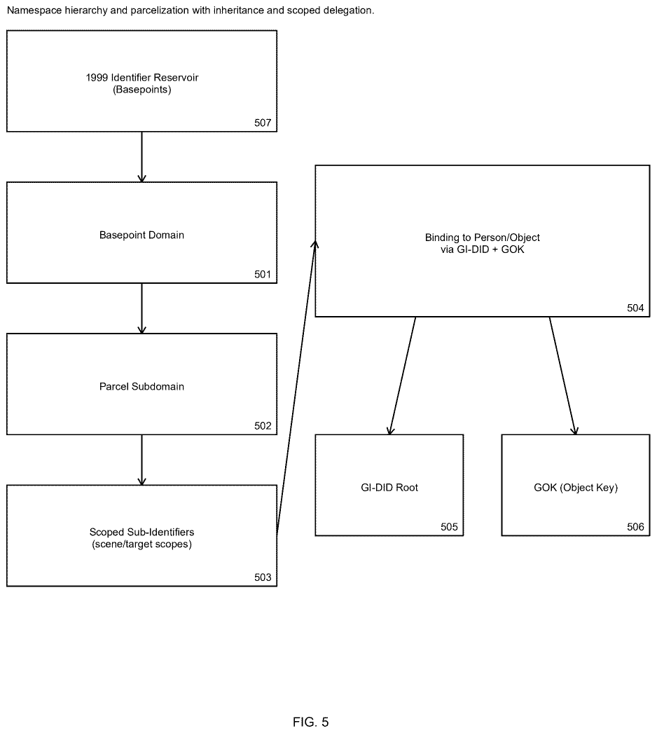

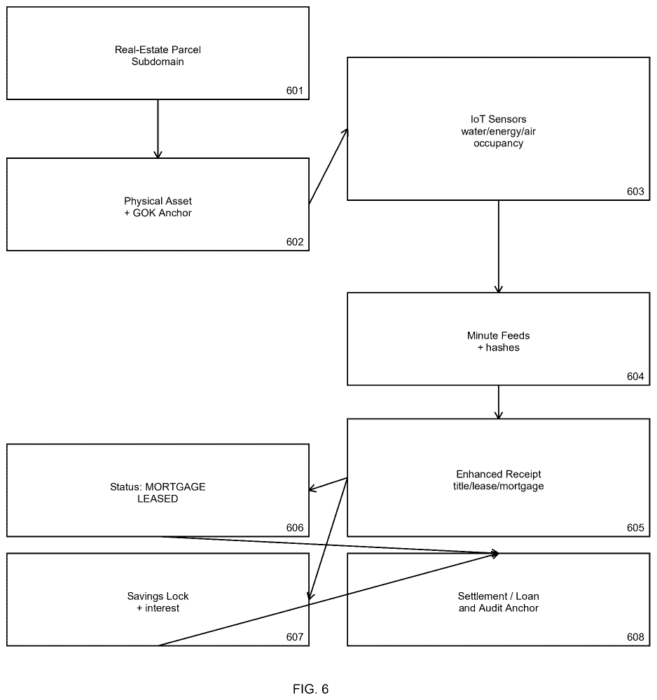

An asset package may include: (i) patent family (US/CN/EP/PCT); (ii) RR and Scope Token schema standards; (iii) SDKs and reference implementations; (iv) pre-established identifier reservoir evidence (Appendix A); and (v) brand and operational domains used as deployment nodes.

| Claim 1 Element | Specification Support | FIGS. |
|---|---|---|
| receive resolution request; | Sections 9, 11.1 | FIG. 1 |
| map to basepoint/parcel | | |
| pre-established identifier | Section 9.2; Appendix A | FIG. 1 |
| reservoir | | |
| load versioned policy | Sections 9.1, 11.1 | FIG. 2 |
| container | | |
| validate Scope Token; | Sections 10.2, 11.1, 12 | FIG. 3 |
| minimum disclosure | | |
| generate RR with | Sections 10.1, 11.1 | FIG. 1 |
| reason/policy/sig/anchor | | |
| bounded rollback; | Section 11.2 | FIG. 4 |
| correction receipts | | |
| optional time-value; index | Sections 10.1, 11.1, 16 | FIG. 5 |
| publication | | |
| optional KG/GI/GOK | Sections 9.1, 10.1, 13 | FIG. 6 |
| bindings | | |

### Appendix A Reference and Inventory Integration

Appendix A (incorporated by reference) provides a non-limiting curated inventory of basepoint identifiers that may be used as resolvable namespace entries for the disclosed system. The inventory may be treated as a reusable and extensible resource reservoir (“Treasure-Bowl”) that can be expanded without departing from the scope of the claims.

For prosecution and enablement, Appendix A may be submitted as a separate attachment and referenced herein as disclosure support for exemplary basepoint naming, categorization, and namespace partitioning strategies.

### Appendix B: Resolution Receipt Schema (Illustrative)

The RR schema referenced herein is provided in a separately filed Code Appendix as a non-limiting example. Alternative encodings (e.g., JSON, CBOR, ASN.1) and additional or fewer fields may be used without departing from the scope of the claims.

Appendix B is filed separately as a Code Appendix containing non-limiting exemplary serialization schemas and test vectors (e.g., a deterministic RR schema). The operative RR field set and semantics are defined in this Specification.

### Appendix C: Scope Token Templates, Denial Reason Codes, and 2026 Activation Nodes

A Scope Token (ST) is a signed authorization object comprising, by way of example, an audience identifier, expiry, purpose/intent, one or more scopes (identity_scope, scene_scope, target_scope), a time_window (or a Time-Domain Coordinate (TDC) path), a privacy_level, a whitelist of fields permitted for disclosure, a policy_pack identifier and version, a nonce, and a cryptographic signature.

A Denial Receipt (DR) comprises at least a machine-readable reason_code and one or more remediation_steps that enable a client to correct inputs and retry, optionally under a retry_policy, while preserving selective disclosure.

Receipt verification may be performed by recomputing deterministic hashes (e.g., policy_hash and audit_anchor), verifying a signature_chain, and confirming that the referenced policy_pack version and time_window constraints are satisfied; an illustrative test vector is provided in the separately filed Code Appendix.

Non-limiting examples of activation nodes and portals registered and/or controlled by the Applicant include:
worldcentralbank.us—public portal for World Minute Central Bank routing and policy publication
worldbankcentral.com—governance and standards portal for time-based monetary policy containers
timeassets.org—time-asset dashboard and standards documentation portal
timeassets.app—client application endpoint for time-asset management and wallet functions
beigi app-global ID (GI) client entrypoint for identity registration and wallet binding
minutebank.org—public-facing retail-minute banking portal and routing entrypoint (non-limiting example)
minuteindex.org—publication endpoint for minute-grade economic aggregation (Global Minute GDP/index snapshots)
beiindex.com—computation endpoint for minute-index coefficients and aggregate streaming inputs
savingsbank.app—client application endpoint for time savings accounts, lockup, compounding, and trust/inheritance controls
beimint.com—minting contract namespace and reference endpoint for time-minting transactions
genesistimecoin.com—minting brand/entrypoint for time coin issuance (non-limiting example)
beitimeminting.com—distributed minting node namespace for modern execution and scaling (non-limiting example)

### Appendix G: Centennial Impact Assessment (Non-Limiting)

This appendix is provided as a non-limiting, illustrative impact assessment intended for contextual disclosure. It summarizes possible civilizational, economic, and governance effects enabled by the disclosed technical mechanisms (policy-governed resolution, cryptographically verifiable RR evidence, minute-grade metering, identity/object anchoring, and real-time index aggregation). This appendix is not required for enablement and shall not be construed as limiting any claim.
Over a multi-decade horizon, time-denominated accounting can standardize cross-context settlement by referencing a common time unit and an index publication mechanism.
Resolution receipts and audit anchoring may reduce fraud and improve transparency in multi-party transactions by enabling machine-verifiable evidence of activity, policy, and settlement state.
Where implemented with privacy modes and bounded rollback procedures, the system can support controlled disclosure while retaining auditability under policy-defined conditions.
Infrastructure embodiments, including real-estate and IoT anchoring, can convert physical resource usage and condition measurements into verifiable, auditable settlement records.
Minute-grade indices may enable near-real-time macroeconomic instrumentation for governments and enterprises, reducing reliance on delayed batch GDP reporting.
Time-denominated settlement may support new benefit and subsidy models (e.g., education or healthcare time credits) while preserving auditability and privacy via selective disclosure.
A time savings account embodiment may support lockup, compounding, and inheritance controls, with receipt states (e.g., SAVINGS_LOCKED, TRUST, INHERITED) enforced by policy containers.
Real-estate and infrastructure embodiments may bind parcels to GOKs and IoT minute feeds, enabling verifiable lease/mortgage workflows via RR state transitions (e.g., OWNED->MORTGAGE->OWNED).
Cross-jurisdiction policy containers may allow machine-executable compliance (e.g., GDPR, PIPL, MiCA) to be evidenced by RR reason codes and regulation anchors.
Standardization of RR schemas may enable interoperable validation across institutions and chains, enabling licensing of a common verification layer without dependence on a single resolver.

| Input Field | Meaning | |
|---|---|---|
| domain | Identifier string, e.g., | |
| | alice.medicalcenter.us or | |
| | device123.beinode.com | |
| intent | Action intent: access/pay/authorize/ | |
| | read/call API/transfer/revoke/etc. | |
| scopes | identity_scope, scene_scope, | |
| | target_scope | |
| | (scope-based delegation) | |
| time_window | start_at/end_at, or a Time-Domain | |
| | Coordinate (TDC) path | |
| privacy_level | PUBLIC/MINIMAL_DISCLOSURE/ | |
| | ZK_PROOF (or equivalent) | |
| auth_proof | Passkey/WebAuthn signature and/or | |
| | VC/ZK evidence, as required by policy | |
| | | Core Fields (Non- |
| Receipt | When Emitted | Limiting) |
| ER (Evidence Receipt) | Allowed resolution/ | policy_version, |
| | successful binding | reason_code, scope, |
| | | time_window, |
| | | payload_hash, |
| | | signature_chain, |
| | | audit_anchor |
| DR (Denial Receipt) | Denied resolution (missing | reason_code, |
| | auth/policy fail) | remediation_steps[ ], |
| | | retry_policy, |
| | | policy_version, |
| | | audit_anchor |
| SR (Settlement Receipt) | Settlement/minting/locking | bei_duration, |
| | occurs | metering_coeff, |
| | | exchange_rate, |
| | | settlement_ref, |
| | | audit_anchor |
| RR (Rollback Receipt) | Bounded rollback/ | rollback_ref, |
| | correction/reversal | impact_report_hash, |
| | | rollback_window, |
| | | policy_version, |
| | | audit_anchor |

| Field | Example value |
|---|---|
| rollback_ref | BRL:2026-01- |
| | 10T12:00Z:sha256:9c2b...(truncated) |
| trigger | Theft/dispute claim on controller proof for |
| | device123.beinode.com |
| affected_time_range | 2026-01-10T12:00Z to 2026-02- |
| | 09T12:00Z |
| impact_set_hashes | sha256(device123.beinode.com)-b0e3fob |
| | 0b334b6d3; |
| | sha256(.../api)=b85f1e6e1b1e4d7a; |
| | sha256(.../keys/1)=fd2ddbb30ec51b0c; |
| | sha256(tenantA....)=d7e9dfcc0a1ce39d; |
| | sha256(logs....)=fa083c791bbcd93b |
| terminal_rules | Block intents {SETTLE, TRANSFER, |
| | ROTATE_KEY} for impact_set during |
| | affected_time_range; allow |
| | READ_MINIMAL only. |
| signatures | signature_chain verifies under |
| | policy_version=1.2.0 (illustrative). |

| | | Remediation Steps |
|---|---|---|
| Reason Code | Meaning | (Example) |
| DR-001 | Missing authentication | Provide |
| | proof | WebAuthn/Passkey |
| | | signature bound to GI- |
| | | DID; retry |
| DR-002 | Scope token | Request renewed Scope |
| | invalid/expired | Token with correct |
| | | audience and time_window |
| DR-003 | Policy PackSet mismatch | Select correct |
| | | jurisdiction/industry |
| | | PackSet; retry with |
| | | packset_version |
| DR-004 | Selective disclosure | Provide VC or ZK proof |
| | required | for requested field set; |
| | | retry |
| DR-005 | Controller proof revoked | Rotate controller key; |
| | | publish revocation state; |
| | | retry |
| DR-006 | Confidence below | Provide higher-confidence |
| | threshold | KG evidence or manual |
| | | attestation; retry |
| DR-007 | Resource telemetry | Reconcile IoT hash feed; |
| | inconsistent | submit calibration receipt; |
| | | retry |
| DR-008 | Rollback window | Proceed with non-rollback |
| | exceeded | remediation path; generate |
| | | corrective transfer receipt |

| Identifier | |
|---|---|
| (Example) | Illustrative Role |
| ATMS.COM | Resolve Gateway/Genesis Resolver |
| minuteindex.org | Public minute-grade aggregation endpoint |
| | (index publisher) |
| beiindex.com | Index computation engine (internal) |
| minutebank.org | Public portal/access point for minute |
| | banking services |
| savingsbank.app | Client wallet/savings lock/trust |
| | interface |
| timeassets.org | Standards and metadata publication node |
| timeassets.app | User-facing asset wallet/dashboard |
| | distribution node |
| beigi.app | Global Identity quickstart gateway |
| beinode.com | IoT and device namespace example |
| beiedge.com | Edge compute and commerce namespace |
| | example |
| Field | Description |
| receipt_type | ER/DR/SR/RR |
| receipt_id | Unique identifier (hash of canonical body) |
| policy_version | Version of policy container used |
| packset_version | Version of PackSet bundle |
| | (jurisdiction/industry) |
| domain | Identifier being resolved |
| intent | Intent enumerator |
| time_window | Start/end bounds used in decision |
| reason_code | Success/denial/rollback reason |
| | enumerator |
| signature_chain | One or more signatures (gateway, |
| | optional controller, optional auditor) |
| audit_anchor | Digest anchor reference (local/BEI log |
| | and optional chain) |

| Item | Value |
|---|---|
| canonical_message | domain=alice.medicalcenter.us\npolicy_v |
| | ersion=1.2.0\nnonce=9f1c2e3a4b5c6d7e\n |
| | start=2026-01-13T00:00:00Z\nend=2026- |
| | 01-13T00:15:00Z\n |
| sha256(canonical_message) | a2351c37b7edd874003fa2928735ad10862 |
| | 5b06ff73cfea201ae0bd69db41d76 |
| ed25519_public_key (hex) | 03a107bff3ce10be1d70dd18e74bc09967e |
| | 4d6309ba50d5f1ddc8664125531b8 |
| ed25519_signature (hex) | b088e9650a92e6c48b40d0c7ad9dea45ddc |
| | 629ff35b0e4b083558dd92a918b04f72fc1 |
| | 77aab9155ac5d001dd52911ed701fda444a |
| | d1c25d0d653bd713867ea0b |
| verification_expected | TRUE |
| note | Keys shown are for test purposes only; |
| | production keys SHALL be generated |
| | securely. |

| Scope Token Field | Meaning | |
|---|---|---|
| aud | Intended audience (gateway or service) | |
| sub | Subject GI-DID | |
| scopes | identity_scope/scene_scope/target_scope | |
| time_window | Start/end bounds | |
| nonce | Anti-replay | |
| field_whitelist | Fields allowed to disclose | |
| regulation_id | Regulatory profile hash | |
| sig | Signature of issuer | |
| KPI | Definition (Non-Limiting) | |
| kpi_dispute_rate | count(RR where reason_code indicates | |
| | refund)/count(SR) | |
| kpi_denial_rate | count(DR)/count(total requests) | |
| kpi_privacy_compliance | ratio of MINIMAL_DISCLOSURE/ZK to | |
| | total sensitive intents | |
| kpi_iot_integrity | ratio of accepted telemetry vs DR-007 | |
| kpi_rollback_latency | median time from rollback request to RR | |
| | issuance | |
| Threat | Mitigation (Non-Limiting) | |
| Replay attack on auth_proof | Nonce + time_window binding; DR-002 | |
| | on replay; passkey sign-in binding | |
| Downgrade attack on | Policy forces minimum privacy; DR- | |
| privacy_level | 003/DR-004 on violations | |
| Key compromise of | Revocation/rotation state; ER references | |
| controller | controller_proof_hash | |
| Gateway compromise | Signature_chain includes auditor co- | |
| | signature; external verification; multi-log | |
| | anchoring | |
| Telemetry spoofing | IoT signed measurements; calibration | |
| | receipts; DR-007 on inconsistencies | |
| Denial of service | Rate limits; cached PackSets; circuit | |
| | breaker emits DR with retry_policy | |
| Information leakage | Selective disclosure; ZK proofs; store | |
| | hashes only on public anchors | |
| Existing Technology | What It Provides | What GKOT-SP Adds |
| | | (Non-Limiting) |
| DNS | Name resolution/records | No policy receipts, no |
| | | denial semantics, no |
| | | rollback, no metering |
| DNSSEC | Integrity of DNS records | Does not emit |
| | | ER/DR/SR/RR or reason |
| | | codes |
| DoH/DOT | Encrypted transport for | Transport security only; no |
| | DNS queries | governed receipts |
| DID | Decentralized identifier | Does not define receipt |
| | document model | ledgers, denial registries, |
| | | rollback constraints |
| Blockchain receipts | Anchoring of event digests | Absent resolver policy |
| | | execution + scope/time- |
| | | window delegation |

| Code Range | Category |
|---|---|
| 001-099 | Identity, access, enrollment, consent, |
| | authentication |
| 100-199 | Education, training, credentialing, |
| | assessment |
| 200-299 | Mobility, logistics, travel, transit |
| 300-399 | Commerce, payments, disputes, escrow |
| 400-499 | Healthcare, clinical services, insurance |
| | claims |
| 500-599 | Utilities/resources: water, energy, |
| | environment, telecom |
| 600-699 | Government services, compliance, |
| | taxation, legal |
| 700-799 | Media/IP, communications, content |
| | licensing |
| 800-899 | Real estate, built environment, |
| | construction, facilities |
| 900-999 | Long-horizon/space/reserved for future |
| | domains |

| | | Typical Intent/Trigger |
|---|---|---|
| Demand Code | Label (Illustrative) | (Illustrative) |
| 001 | Access/Resolve | Name discovery; fetch |
| | | public endpoints |
| 005 | Medical Visit | Clinical encounter; |
| | | eligibility/consent gate |
| 020 | Payment/Settlement | Initiate settlement; produce |
| | | Settlement Receipt |
| 033 | Authorization Grant | Issue/update Scope Token; |
| | | delegate fields/actions |
| 050 | Account Recovery | Key rotation; revocation |
| | | lookup |
| 070 | Dispute/Claim | Open dispute; freeze |
| | | lifecycle state |
| 100 | Learning/Study | Education minutes; accrual |
| | | and/or credential request |
| 120 | Examination/Certification | Verification; QUALIFIED |
| | | status |
| 200 | Bandwidth/Compute | Meter |
| | | network/storage/compute |
| | | minutes |
| 210 | Mobility/Transit | Trip settlement; |
| | | TRIP_COMPLETED |
| | | status |
| 300 | Real-Estate Lease | Lease lifecycle; LEASED |
| | | status |
| 310 | Mortgage/Collateral | Collateral lock; |
| | | MORTGAGE status |
| 900 | Administrative/System | Policy update; registry |
| | | maintenance |
| 001-999 | Reserved range | Additional codes may be |
| | | defined. Codes may be |
| | | grouped by ranges (e.g., |
| | | 001-099 access/identity; |
| | | 100-199 education; 200- |
| | | 299 compute/mobility; |
| | | 300-399 real-estate). |

| Code Range | Industry Family |
|---|---|
| 001-040 | Healthcare & Life Sciences |
| 041-080 | Education & Research |
| 081-120 | Finance, Banking, Insurance |
| 121-160 | Retail, Commerce, Marketplaces |
| 161-200 | Transportation, Logistics, Mobility |
| 201-240 | Utilities, Energy, Water, Environment |
| 241-280 | Manufacturing, Industrial, Supply Chain |
| 281-320 | Government, Legal, Public Safety |
| 321-350 | Media, Telecom, Internet Services |
| 351-365 | Real Estate & Built Environment |

| | | Typical Context |
|---|---|---|
| Industry Code | Industry (Illustrative) | (Illustrative) |
| 001 | General/Cross-Industry | Default when no |
| | | specialization applies |
| 007 | Healthcare/Oncology | Clinical services and |
| | | oncology workflows |
| 010 | Healthcare/General | General medical services |
| 050 | Education/K-12 | Primary and secondary |
| | | education |
| 060 | Education/Higher Ed | Universities and vocational |
| | | programs |
| 100 | Finance/Banking | Retail and commercial |
| | | banking |
| 110 | Insurance | Health/property/life |
| | | insurance |
| 150 | Software/IT Services | Software development and |
| | | managed services |
| 170 | Telecom/Network | Carrier and connectivity |
| | | services |
| 200 | Energy/Utilities | Electricity generation and |
| | | distribution |
| 210 | Water/Waste | Water supply and |
| | | wastewater treatment |
| 250 | Real Estate | Property leasing, mortgage, |
| | | titling |
| 300 | Government | Public administration, |
| | | compliance, benefits |
| 001-365 | Reserved range | Additional codes may be |
| | | defined. Codes may be |
| | | grouped by ranges and/or |
| | | mapped from standard |
| | | industry classifications. |

| Factor | Example Range | Notes | | |
|---|---|---|---|---|
| w_industry(I) | 0.5-3.0 | Policy-set per industry | | |
| | | family | | |
| w_demand(D) | 0.5-5.0 | Higher for scarce/high- | | |
| | | impact demands | | |
| w_trust(T) | 0.8-1.5 | Higher for stronger proofs/ | | |
| | | attestations | | |
| w_quality(Q) | 0.7-1.3 | IoT integrity, audit grade, | | |
| | | data completeness | | |
| w_region(R) | 0.5-2.0 | Jurisdictional or local | | |
| | | index adjustments | | |
| Tier | Scope | Illustrative Pricing | | |
| | | Structure | | |
| Sovereign | National platforms, central | Annual subscription + per- | | |
| | banks, regulators | event metering | | |
| | | (negotiated) | | |
| Industry | Sector consortia (health, | One-time integration | | |
| | energy, finance) | license + maintenance | | |
| Enterprise | Single enterprise | Per-seat/per-node + receipt | | |
| | deployment | volume | | |
| Developer | SDK/verifier usage | Per-API call/open-core | | |
| | | model | | |
| Term | Meaning | | | |
| Basepoint | A root identifier entry used to derive | | | |
| | scoped sub-identifiers and bind policy. | | | |
| Resolve Gateway | A governance layer endpoint located via | | | |
| | DNS discovery that emits receipts. | | | |
| ER/DR/SR/RR | Evidence, Denial, Settlement, and | | | |
| | Rollback Receipts. | | | |
| PackSet | A signed bundle of versioned policy | | | |
| | modules for a scope/jurisdiction/industry. | | | |
| Selective | Return of only permitted fields based on | | | |
| Disclosure | privacy_level and proofs. | | | |
| Bounded Rollback | Constrained correction mechanism with | | | |
| | an impact report, avoiding cascade | | | |
| | effects. | | | |
| GI-DID | Global identity root (decentralized | | | |
| | identifier or equivalent). | | | |
| GOK | Global object key (content-addressable | | | |
| | object identifier). | | | |
| TDC | Time Domain Coordinate (time-bounded | | | |
| | delegation path). | | | |
| Field | Meaning | | | |
| rollback_ref | Receipt_id being rolled back | | | |
| affected_ | List of downstream receipt_ids impacted | | | |
| receipts[ ] | | | | |
| affected_ | Identifiers whose state transitions are | | | |
| identifiers[ ] | affected | | | |
| affected_indices[ ] | Index snapshots to recompute or annotate | | | |
| remediation_ | Receipts required to restore consistency | | | |
| receipts[ ] | | | | |
| max_depth | Rollback depth constraint | | | |
| time_window | Rollback time constraint | | | |
| Category | Examples (Non-Limiting) | | | |
| Identity | bei.app, beigi.app, beidid.com, . . . | | | |
| Minting/ | beimint.com, genesistimecoin.com, . . . | | | |
| Settlement | | | | |
| Index/Analytics | beiindex.com, minuteindex.org, | | | |
| | beikpi.com, . . . | | | |
| Banking/Savings | minutebank.org, savingsbank.app, | | | |
| | timeassets.app, . . . | | | |
| IoT/Devices | beinode.com, beiedge.com, | | | |
| | beihost.com, . . . | | | |
| Status | Meaning | Typical Receipts | | |
| ACTIVE | Normal operation; binding | ER, SR | | |
| | valid | | | |
| LEASED | Time-bounded delegated | ER, SR | | |
| | occupancy/usage | | | |
| MORTGAGE | Collateral lock active | SR (lock), ER (state) | | |
| SAVINGS_ | Minutes locked in | SR, ER | | |
| LOCKED | savings/trust | | | |
| FROZEN | Administrative or fraud | DR, ER | | |
| | hold | | | |
| REVOKED | Controller revoked; | DR, ER | | |
| | binding invalid | | | |
| ETERNAL | Long-horizon inheritance | ER, SR | | |
| | mode (policy-governed) | | | |
| | | | | Emitted |
| From | To | Trigger | Guard | Receipts |
| ACTIVE | LEASED | lease_start | valid scope | ER + SR |
| | | | token + | |
| | | | time_window | |
| LEASED | ACTIVE | lease_end | time_window | ER |
| | | | expiry | |
| ACTIVE | MORTGAGE | collateral_lock | credit policy | SR + ER |
| | | | satisfied | |
| MORTGAGE | ACTIVE | unlock | repayment | SR + ER |
| | | | receipt verified | |
| ANY | FROZEN | fraud_alert | policy | DR + ER |
| | | | authority | |
| | | | signature | |
| FROZEN | ACTIVE | release_hold | investigation | ER |
| | | | closure | |
| ACTIVE | REVOKED | key_revocation | controller | DR + ER |
| | | | revocation | |
| | | | published | |

| Field | Meaning |
|---|---|
| duration_limit | e.g., 999 years or statutory lease term |
| value_floor | minimum collateral minutes |
| gok_hash | content-addressable object key for parcel |
| iot_feed_hash | rolling hash commitment of telemetry |
| energy_minutes | accumulated maintenance minutes |
| savings_rate | adjusted rate based on efficiency/quality |

### Consumer-Facing Minute Receipt Portals (Non-Limiting: BEIBILL.COM; BEIRECEIPT.COM)

Some embodiments include consumer-facing portals that expose resolution receipts as familiar “bills,” “receipts,” or “invoices” to enable rapid user comprehension and adoption without requiring protocol knowledge.

Example Portal A (Minute Bill). A portal hosted at an illustrative domain (e.g., BEIBILL.COM) receives a user identifier (email/phone) and a request to mint or retrieve a minute-grade bill. The portal invokes the resolver gateway to generate an RRec that includes bei_duration, bei_value, status, audit_anchor, and signature_chain, and transmits the RRec to the user (e.g., email/SMS) as an electronic bill statement.

Example Portal B (Resolution Receipt). A portal hosted at an illustrative domain (e.g., BEIRECEIPT.COM) issues a verifiable receipt for a resolution event (success or denial). The receipt may be rendered as a human-readable invoice and may include a machine-readable payload (e.g., QR encoding the RRec hash and verification endpoint).

These portals demonstrate that the same protocol layer can serve both machine integrations (API/SDK) and human-facing “receipting” experiences, and they provide evidence artifacts usable for disputes, refunds, chargeback-style remediation, compliance attestations, and user-controlled sharing.

### Rollback Impact Report Example (Anti-Domino, Non-Limiting)

Some embodiments emit an Impact Report as part of a bounded rollback receipt (RR) to prevent cascade failures (“anti-domino”). The Impact Report may include a rollback_ref (snapshot pointer), an affected-set list (hashed identifiers), and client response rules.

Example: a disputed medical-access authorization is detected within a bounded rollback window. The governance service freezes the binding and emits RR+Impact Report:
rollback_ref: brl://snapshot/0a3211b6cc9257d8
Affected identifiers (SHA-256 prefix, 16 hex chars):
alice.medicalcenter.us->f8bc8e1f0c2275d9
alice.billing.beibill.com->5c7049ee82b2e54a
device123.beinode.com->1ef368a1e1f4ace0
clinic1.medicalcenter.us->3d1cce4638ae0b04
Impact time_window: 2026-01-14T05: 05:22Z to 2026-01-14T06: 05:22Z.

Client rule: upon receiving an Impact Report whose affected-set contains the subject identifier hash prefix, the client MUST block privileged operations, purge caches for the impacted identifiers, and require refreshed authorization proof (e.g., renewed ST) before reconnecting.

### Reason-Code Pack and Remediation Hints (Examiner-Friendly Core Set)

In some embodiments, denial is not treated as a silent failure. Instead, the resolver gateway emits a Denial Receipt (DR) that includes a reason_code and remediation_steps, such that clients can programmatically guide recovery. The following non-limiting core set illustrates machine-readable denial semantics:
RC-00 OK: Resolution permitted.
RC-01 AUTH_DENIED: Authorization proof missing or invalid. Remediation: obtain a valid Scope Token (ST) or WebAuthn/Passkey proof.
RC-02 SCOPE_VIOLATION: Requested fields or actions exceed the authorized scope. Remediation: request narrower fields or obtain expanded scope.
RC-03 PRIVACY_MIN_DISCLOSURE: Sensitive subject; only challenge endpoint returned. Remediation: provide selective-disclosure VC or ZK proof.
RC-04 POLICY_BLOCKED: Policy Container rules prohibit requested intent. Remediation: change intent or satisfy additional prerequisites.
RC-05 REVOKED_OR FROZEN: Identifier or controller state revoked/frozen. Remediation: follow recovery/appeal workflow; check revocation_ref.
RC-06 STALE_OR_EXPIRED: Time window expired or TTL exceeded. Remediation: refresh request within a new time_window.
RC-07 ROLLBACK_IN PROGRESS: Identifier in dispute/rollback workflow. Remediation: wait or submit required dispute evidence; consult rollback ref.
RC-08 INTEGRITY_FAIL: Signature chain or audit anchor verification failed. Remediation: re-fetch from authoritative gateway; reject caches.
RC-09 RATE LIMITED: Governance throttling applied. Remediation: backoff and retry per retry policy.
RC-10 NOT_FOUND: No resolvable binding found under current policy. Remediation: register/claim basepoint or check correct namespace.

### Standardization and Interoperability (Non-Limiting)

In non-limiting embodiments, the BEI TRD protocol (also referred to herein as BEIDNS) is designed to be standards-adjacent and interoperable with existing Internet, identity, and security specifications while introducing a new governance layer above discovery resolution. The disclosures below are provided to improve interoperability, repeatability, and third-party verification, and do not limit the scope of the claims.

A. Interoperability with Existing Resolution Standards

Discovery may be performed using conventional name-to-endpoint mechanisms (e.g., DNS resource records including HTTPS/SVCB/URI records and similar service-binding records), and encrypted transport mechanisms (e.g., DoH/DoT) may be used for confidentiality of the query transport. In all such cases, the governance, authorization, selective disclosure, and receipt issuance occur in the resolver gateway layer described in this specification.

B. Interoperability with Identity and Attestation Standards

For identity anchoring, the protocol may interoperate with decentralized identifier document formats and verifiable credential models (e.g., W3C DID and VC models) as non-limiting examples. Strong client authentication may interoperate with WebAuthn/Passkeys for proof-of-control and anti-phishing authentication. These are illustrative integration points; other identity and attestation schemes may be used.

### C. Cryptographic Encodings and Receipt Canonicalization

Resolution Receipts (RRec) may be encoded in a deterministic form to enable third-party recomputation and verification. Non-limiting encodings include canonical JSON, CBOR, and/or deterministic protobuf. Signatures may be represented using standard signature containers (e.g., COSE and/or JOSE) with algorithm agility. Audit anchors may be represented as Merkle roots, content-addressable digests (e.g., CID-style digests), or other append-only log commitments.

### D. Conformance Profiles and Registries

To support multi-vendor interoperability, implementations may publish conformance profiles for (i) receipt formats, (ii) reason-code vocabularies, (iii) scope-token claim sets, and (iv) policy-container versioning and migration. In non-limiting embodiments, a public or consortium registry may be maintained for reason codes, policy-pack identifiers, and receipt field semantics so that independent verifiers can validate receipts produced by different resolver gateways.

### E. Technical Whitepaper/Bluepaper/Technical Review Attachments

A separate non-essential technical attachment entitled “BEI TRD (BEIDNS) Technical Whitepaper, Bluepaper, and Technical Review” may be submitted with this application as an informational appendix. Such attachment may include conformance guidance, deployment profiles, sample test vectors, and additional use-case packs. The present specification is complete without reliance on the technical attachment for compliance with 35 U.S.C. Section 112.

1. A computer-implemented method of policy-governed identifier resolution, the method comprising:
(a) receiving, from a client computing device, an identifier request that includes (i) an identifier associated with a resolvable namespace, (ii) an intent value, and (iii) a time indicator comprising a time window or a time-domain coordinate;
(b) selecting, from a pre-established curated inventory of namespace basepoints, a basepoint for the identifier request, wherein the basepoint is selected by matching one or more attributes of the identifier request to one or more basepoint selection rules;
(c) retrieving a versioned policy container associated with the selected basepoint and executing the policy container using a policy engine to determine at least one authorization decision and at least one disclosure rule for the identifier request;
(d) validating a scope token against the versioned policy container, wherein the scope token specifies at least a scope, a time constraint, and a field-level disclosure whitelist or permission set;
(e) generating a resolution receipt record (RRec) that is cryptographically verifiable and that includes at least: (i) a result set or a denial indication, (ii) a reason code, (iii) a policy hash and a policy version identifier, (iv) a scope-token reference or scope-token digest, (v) a revocation reference, (vi) a rollback reference, (vii) a time-to-live value, (viii) an audit anchor, and (ix) a signature chain or authenticity proof; and
(f) writing an anchor digest of the RRec to an append-only receipt ledger, and returning the RRec to the client computing device regardless of whether the authorization decision allows or denies access.

2. A computer-implemented method performed at a client device for independent verification and gating of a policy-governed resolution response, the method comprising:
(a) receiving, in response to an identifier request, an RRec generated by a resolver;
(b) independently verifying, using locally stored verification logic, at least (i) a signature chain or authenticity proof of the RRec, (ii) a policy hash and a policy version identifier referenced by the RRec, (iii) a revocation reference of the RRec, and (iv) an anchor digest of the RRec in an append-only receipt ledger or in a distributed-ledger anchor;
(c) determining, based on (i) a reason code of the RRec, (ii) a scope-token reference or scope-token digest of the RRec that corresponds to a field-level permission set, and (iii) a rollback reference of the RRec, whether to allow a connection, a transaction, or a data disclosure associated with the identifier request; and
(d) when access is denied, blocking the connection, transaction, or data disclosure and outputting machine-readable remediation guidance based on the reason code.

3. A non-transitory computer-readable storage medium storing instructions that, when executed by one or more processors, cause performance of the method of claim 1, and further storing a deterministic serialization definition for the RRec such that the RRec is independently verifiable by a third-party verifier without requiring trust in the resolver.

4. The method of claim 1, wherein the identifier request is transported using an encrypted name-resolution or transport protocol comprising at least one of DNS over HTTPS (DoH), DNS over TLS (DOT), or a TLS-protected application-layer request.

5. The method of claim 1, wherein a DNS discovery response comprises at least one of a URI resource record, an HTTPS/SVCB resource record, or a canonical name record that directs the client computing device to a resolution gateway endpoint that generates the RRec.

6. The method of claim 1, wherein, responsive to determining that the intent value targets a sensitive object class comprising at least one of identity, health, finance, or asset control, the policy engine causes a challenge endpoint to be returned and requires an authentication proof comprising at least one of WebAuthn, a passkey signature, a verifiable credential, or a zero-knowledge proof.

7. The method of claim 1, wherein the scope token includes an audience field, an expiration field, the time constraint, and the field-level disclosure whitelist.

8. The method of claim 7, further comprising generating the scope token responsive to a relationship proof that indicates an authorized relationship between a requester and a target entity, the relationship proof comprising at least one of an issuer-signed credential or a policy-approved attestation.

9. The method of claim 1, wherein the policy engine enforces selective disclosure by returning, for a denied request, a denial receipt that includes the reason code and a remediation step list, and by returning, for an allowed request, only fields permitted by the field-level disclosure whitelist.

10. The method of claim 7, wherein issuance of the scope token requires a threshold signature by a plurality of policy authorities and supports nested delegation by including a parent-token reference.

11. The method of claim 1, wherein the RRec includes a plurality of standardized reason codes corresponding to at least: authentication failure, authorization failure, policy mismatch, scope violation, expiry, revocation, rollback-in-progress, and compliance restriction.

12. The method of claim 1, wherein the audit anchor includes (i) a hash of the result set or denial indication and (ii) a ledger reference that enables independent verification by a third party, and wherein the anchor digest is optionally additionally anchored to a distributed ledger via a digest-only commitment.

13. The method of claim 1, further comprising enriching the identifier request with knowledge-graph data by mapping the identifier request to a knowledge-graph entity identifier and recording, in the RRec, at least a knowledge-graph entity identifier and a knowledge-graph path hash.

14. The method of claim 1, further comprising generating or retrieving a global identity root for a subject and generating a global object key for an object associated with the identifier request, and recording, in the RRec, a decentralized identifier for the global identity root and a cryptographic hash for the global object key.

15. The method of claim 1, further comprising computing minute-grade metering values comprising a duration value and a computed value amount, recording the duration value and the computed value amount in the RRec, and streaming aggregated metering values to a real-time index publication service to produce a minute-resolution economic index.

16. The method of claim 1, further comprising locking at least a portion of the computed value amount into a savings state that includes an interest or yield parameter and an inheritance or trust release condition, and recording the savings state in the RRec.

17. The method of claim 1, wherein the identifier request is associated with a physical asset, and further comprising receiving IoT measurements for the physical asset, generating an IoT data anchor, recording the IoT data anchor in the RRec, and updating an RRec status value to indicate at least one of MORTGAGE, LEASED, or TRANSFERRED for the physical asset.

18. The method of claim 1, wherein the scope token references a regulation identifier or compliance profile, and wherein the policy engine automatically applies a compliance state comprising at least one of minimal disclosure or full compliance and records the compliance state in the RRec.

19. The method of claim 1, further comprising, in response to a revocation signal, inconsistency detection, or control-change event associated with an identifier, executing a bounded rollback procedure that: (i) references a previously committed snapshot of an append-only receipt ledger via a rollback_ref field; (ii) computes an impact set that identifies only those resolution receipts and derived records whose dependency graph cryptographically commits to the revoked or inconsistent receipt; and (iii) issues a rollback resolution receipt (RRec) that includes the rollback_ref, an impact_set_digest, and a machine-readable remediation directive, thereby preventing cascading invalidation outside the computed impact set.

20. The method of claim 19, wherein the bounded rollback procedure is constrained to a predetermined rollback window defined by at least one of (a) a time-duration threshold and (b) a metered-minute threshold, and wherein the bounded rollback procedure further generates a rollback impact report comprising: (i) one or more hashed identifier prefixes representing affected identifiers; (ii) an affected time range; (iii) a verification rule for a client terminal that, responsive to the rollback impact report and the rollback resolution receipt, denies, quarantines, or re-requests access until a replacement RRec verifies against a policy_version and a revocation_ref.
